(19) United States
(12) Patent Application Publication
(10) Pub. No.: US 2014/0182082 A1
(43) Pub. Date: Jul. 3, 2014

(54) HANDLE ASSEMBLY

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: LIN-HAN WU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/033,755

(22) Filed: Sep. 23, 2013

(30) Foreign Application Priority Data
Dec. 28, 2012 (CN) 201210582582X

(51) Int. Cl. B25G 1/02

(52) U.S. Cl. CPC B25G 1/02
USPC 16/114.1

(57) ABSTRACT

A handle assembly includes a handle band, a latch member connected to the handle band, and a mounting member connected to the latch member. The handle band includes a main portion and a pair of overlapping portions extending from opposite ends of the main portion and abutting an inner side of the main portion. A mounting hole is formed at a joint portion between the main portion and each of the pair of overlapping portions. The latch member is pivotably mounted in the mounting hole. The mounting member includes a mounting piece pivotably connected to the latch member and at least one mounting tab extending from the mounting piece for mounting the handle assemble to a device.

### BACKGROUND

1. Technical Field

The present disclosure relates to a handle assembly.

2. Description of Related Art

A handle band is usually attached to a device for facilitating the carrying of the device. The handle band is made from Nylon material, metal material, plastic material, or other material. Two ends of the handle band are adhered or welded to the device. It can be inconvenient to install or uninstall the handle band.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an embodiment of a handle assembly.

FIG. 2 is similar to FIG. 1, but viewed from another aspect.

FIG. 3 is an assembled view of the handle assembly of FIG. 1.

FIG. 4 is a partial view of the handle assembly of FIG. 3, viewed from another aspect.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean “at least one.”

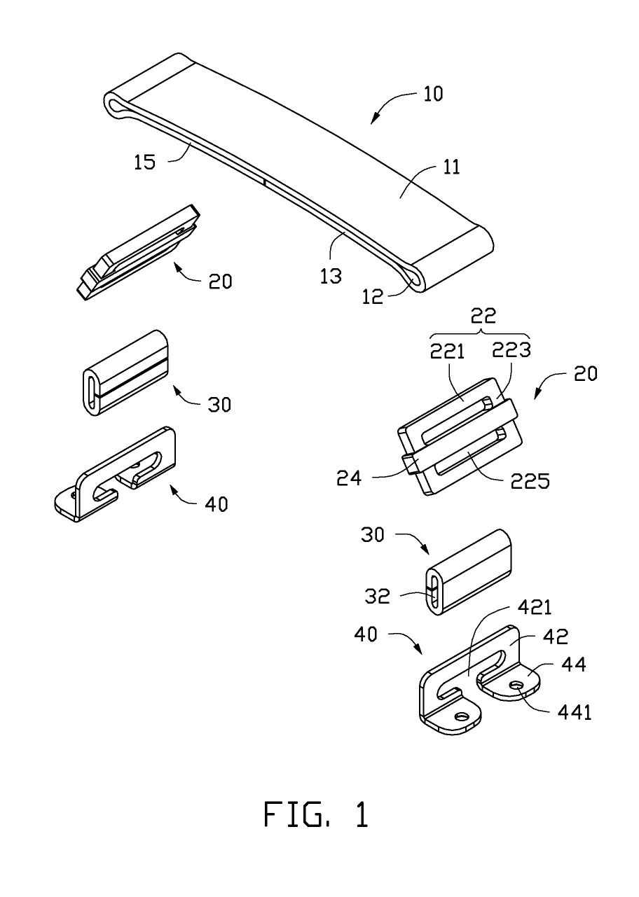

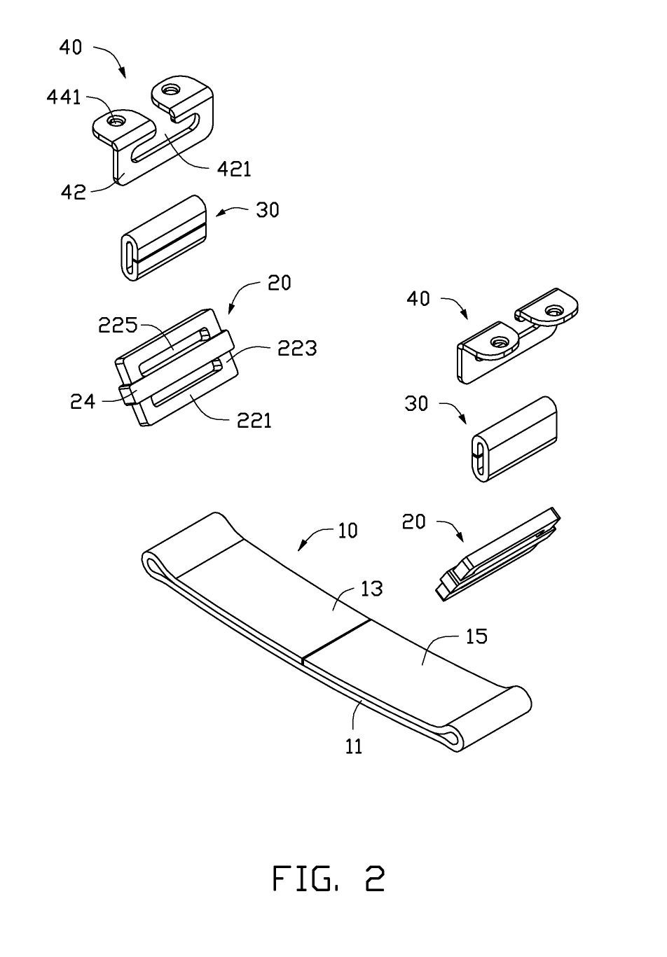

FIGS. 1 and 2 show an embodiment of a handle assembly. The handle assembly includes a handle band 10, a pair of latch members 20, a pair of connecting members 30, and a pair of mounting members 40. In one embodiment, the handle band 10 and the pair of connecting members 30 are made from flexible material, such as Nylon. Each of the pair of latch members 20 and each of the pair of mounting members 40 are made from rigid material, such as metal.

The handle band 10 is integrally formed. The handle band 10 includes a main portion 11, a first overlapping portion 13, and a second overlapping portion 15. The first overlapping portion 13 and the second overlapping portion 15 are connected to opposite ends of the main portion 11 and abut an inner side of the main portion 11. The handle band 10 includes a pair of mounting holes 12. One of the pair of mounting holes 12 is formed at a first joint portion between the main portion 11 and the first overlapping portion 13. The other one of the pair of mounting holes 12 is formed at a second joint portion between the main portion 11 and the second overlapping portion 15. Distal ends of the first overlapping portion 13 and the second overlapping portion 15 abut each other. The handle band 10 has a two-layer structure.

Each of the pair of latch members 20 includes a frame 22 and a dividing strip 24 connected to the frame 22. The frame 22 substantially has a rectangular shape and includes a pair of long rods 221 and a pair of short rods 223. The dividing strip 24 is perpendicularly connected to a central portion of each of the pair of short rods 223. A pair of mounting slots 225 is defined in the frame 22 and located at opposite sides of the dividing strip 24. A width of the handle band 10 is not greater than a length of each of the pair of mounting slots 225. A thickness of one layer of the handle band 10 is not greater than a width of each of the pair of mounting slots 225.

Each of the pair of connecting members 30 has a substantially ring shape. The connecting member 30 is made from a bent band. A mounting groove 32 is surrounded by the bent band. Two ends of the bent band abut each other. A width of the connecting member 30 is substantially equal to the width of the handle band 10.

Each of the pair of mounting members 40 includes a mounting piece 42 and a pair of mounting tabs 44 extending substantially perpendicularly from a lower edge of the mounting piece 42. A mounting opening 421 is defined in the mounting piece 42. The mounting opening 421 substantially has a substantially T shape. The mounting opening 421 includes a narrow portion connected to the lower edge of the mounting piece 42 and a wider portion connected to the narrow portion. A gap is located between the pair of mounting tabs 44 and connected to the narrow portion. A securing hole 441 is defined in each of the pair of mounting tabs 44. The mounting opening 421 is wide enough to engage with the connecting member 30.

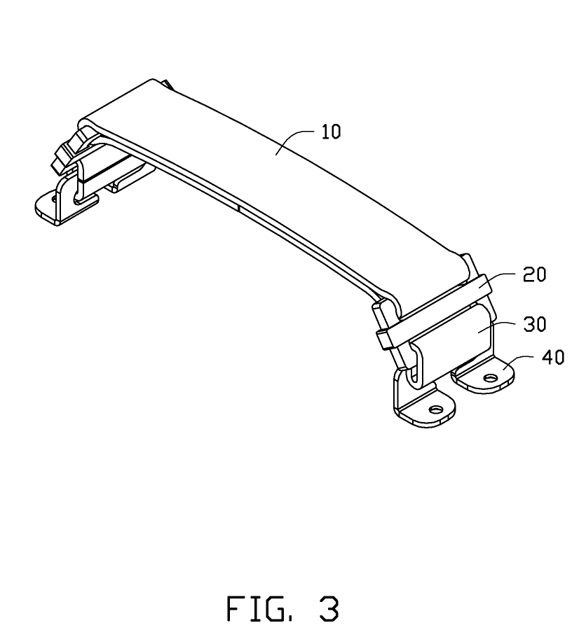

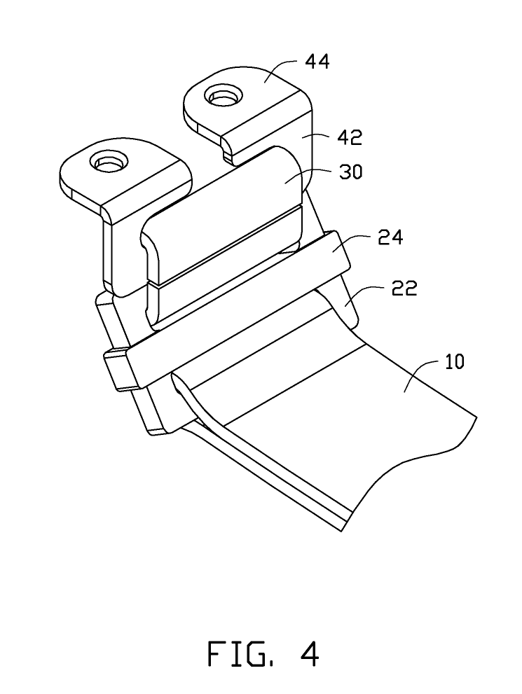

FIGS. 3 and 4 show in assembly, each of the first overlapping portion 13 and the second overlapping portion 15 extends through one of the pair of mounting slots 225. One of the pair of long rods 221 is mounted in the mounting hole 12. Each of the first overlapping portion 13 and the second overlapping portion 15 is secured to the inner side of the main portion 11. The other one of the pair of long rods 221 is mounted in the mounting groove 32. Two ends of the connecting member 30 are secured to each other. One of the pair of mounting tabs 44 is squeezed through the mounting groove 32. Each of the pair of connecting members 30 is engaged with the mounting opening 421. Each of the pair of latch members 20 is pivotably connected to the handle band 10. Each of the pair of connecting members 30 is pivotably connected to one of the pair of latch members 20, and pivotably connected to one of the pair of mounting members 40. Each securing hole 441 is configured to secure the handle assembly to a device. Utilizing the handle assembly, the device can be easily carried from place to place.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A handle assembly comprising:
a handle band comprising a main portion and a pair of overlapping portions extending from opposite ends of the main portion and abutting an inner side of the main portion; and
a pair of mounting members attached to opposite ends of the handle band, each of the pair of mounting members comprising a mounting piece pivotably connected to the handle band and at least one mounting tab extending from the mounting piece for mounting the handle assemble to a device.

2. The handle assembly of claim 1, further comprising a latch member connected to each end of the handle band and a connecting member connected to the latch member, wherein the connecting member is pivotably connected to the mounting piece.

3. The handle assembly of claim 2, wherein a mounting hole is formed at a joint portion between the main portion and each of the pair of overlapping portions for mounting the latch member.

4. The handle assembly of claim 3, wherein the latch member comprises a frame, the frame has a substantially rectangular shape and comprises a pair of long rods and a pair of short rods, a first one of the pair of long rods is pivotably mounted in the mounting hole, and a second one of the pair of long rods is pivotably mounting in the connecting member.

5. The handle assembly of claim 4, wherein the latch member further comprises a dividing strip substantially perpendicularly connected to a central portion of each of the pair of short rods, and a pair of mounting slots is defined in the frame and located besides opposite sides of the dividing strip.

6. The handle assembly of claim 5, wherein the handle band extends through a first one of the pair of mounting slots and surrounds the first one of the pair of long rods, and a connecting member extends through the second one of the pair of mounting slots and surrounds a second one of the pair of long rods.

7. The handle assembly of claim 5, wherein a mounting groove is defined in the connecting member for mounting the latch member, and a mounting opening is defined in the mounting piece for mounting the connecting member.

8. The handle assembly of claim 7, wherein the mounting opening has a substantially T shape.

9. The handle assembly of claim 1, wherein distal ends of the pair of overlapping portions abut each other, and the handle band has a two-layer structure.

10. The handle assembly of claim 2, wherein the handle band and the connecting member are made from flexible material; and the latch member and each of the pair of mounting members is made from rigid material.

11. A handle assembly comprising:
a handle band comprising a main portion and a pair of overlapping portions extending from opposite ends of the main portion and abutting an inner side of the main portion; and a mounting hole being formed at a joint portion between the main portion and each of the pair of overlapping portions;
a latch member pivotably mounted in the mounting hole; and
a mounting member, connected to the latch member, and comprising a mounting piece pivotably connected to the latch member and at least one mounting tab extending from the mounting piece for mounting the handle assemble to a device.

12. The handle assembly of claim 11, further comprising a connecting member pivotably connected to the latch member and the mounting member.

13. The handle assembly of claim 12, wherein the latch member comprises a frame, the frame has a substantially rectangular shape and comprises a pair of long rods and a pair of short rods, a first one of the pair of long rods is pivotably mounted in the mounting hole, and a second one of the pair of long rods is pivotably mounting in the connecting member.

14. The handle assembly of claim 13, wherein the latch member further comprises a dividing strip substantially perpendicularly connected to a central portion of each of the pair of short rods, and a pair of mounting slots is defined in the frame and located besides opposite sides of the dividing strip.

15. The handle assembly of claim 14, wherein the handle band extends through a first one of the pair of mounting slots and surrounds the first one of the pair of long rods, and a connecting member extends through a second one of the pair of mounting slots and surrounds the second one of the pair of long rods.

16. The handle assembly of claim 15, wherein a mounting groove is defined in the connecting member for mounting the latch member and the mounting member, and a mounting opening is defined in the mounting piece for mounting the connecting member.

17. The handle assembly of claim 16, wherein the mounting opening has a substantially T shape.

18. The handle assembly of claim 11, wherein distal ends of the pair of overlapping portions abut each other, and the handle band has a two-layer structure.

19. The handle assembly of claim 12, wherein the handle band and the connecting member are made from flexible material; and the latch member and the mounting member is made from rigid material.

20. The handle assembly of claim 11, wherein a securing hole is defined in the at least one mounting tab for mounting the handle assembly to the device.
